(19) United States
(12) Patent Application Publication
(10) Pub. No.: US 2026/0152970 A1
(43) Pub. Date: Jun. 4, 2026

(54) COMBINATION HASP WITH ADVANCED SECURITY MECHANISM

(71) Applicant: The Sun Lock Company Limited, Tuen Mun, N.T. (HK)

(72) Inventor: Karl LAI, Tai Po, N.T. (HK)

(21) Appl. No.: 19/387,877

(22) Filed: Nov. 13, 2025

Related U.S. Application Data
(60) Provisional application No. 63/726,989, filed on Dec. 2, 2024.

(51) Int. Cl. E05B 13/10; E05B 1/00; E05B 15/00; E05B 65/48

(52) U.S. Cl. CPC E05B 13/103; E05B 1/0007; E05B 15/0033; E05B 65/48

(57) ABSTRACT

The present invention is directed to a combination hasp including a fixed hasp configured for mounting onto a fixture object by one or more fasteners, a movable hasp operatively connected to the fixed hasp and having a cutout formed therein. A knob and inner body operatively connected with a base and configured for rotational movement. The knob has a shape corresponding to the cutout in the movable hasp so that the knob is configured to pass through the movable hasp for operating the combination hasp to an unlocked mode. A lever positioned within the inner body and the knob and including a lock tail configured for engagement with a lock-tail cutout of the base to prevent rotational movement of the knob and the inner body relative to the base when the combination hasp is in a locked mode.

### CROSS-REFERENCE TO RELATED APPLICATIONS

This application claims priority to U.S. Provisional Appl. No. 63/726,989 filed Dec. 2, 2025, which is hereby incorporated by reference in its entirety.

### BACKGROUND OF THE INVENTION

### 1. Field of the Invention

The present invention generally relates to a combination hasp, and more particularly to a combination hasp with advanced security mechanism.

### 2. Related Art

Available products in the current market for combination hasps generally require a correct combination to be set on the dials and a knob rotated to open the hasp. However, an unauthorized intruder could grab the knob with little force and rotate the knob even if the dials are not aligned to the correct combination. What is needed is an improvement to overcome such problem with an advanced push button design that avoids or significantly reduces the likelihood of an unauthorized intruder forcefully opening the combination hasp.

### SUMMARY OF THE INVENTION

An object of the present invention is to provide a combination hasp that avoids or at least significantly reduces the likelihood of an unauthorized intruder forcefully opening the combination hasp.

Another object of the present invention is to provide a combination hasp that requires input of a correct combination in order to open the combination hasp through non-destructive means.

Yet another object of the present invention is to provide a combination hasp having an anti-picking function comprised of one or more clutches, each having one or more faulty gates and one true gate to make it more difficult for an unauthorized to decode the correct combination of the combination hasp.

Still another object of the present invention is to provide a combination hasp that is configured to be secured to a door or gate, in order to control access through the door or gate.

Another object of the present invention is to provide a combination hasp having a combination reset mechanism that provides for resetting and/or reconfiguring of the correct combination for the combination hasp.

In accordance with these and other objects of the present invention, a combination hasp is provided that may include a fixed hasp configured for mounting onto a fixture object by one or more fasteners, a movable hasp operatively connected to the fixed hasp and having a cutout formed therein, a knob operatively connected with a base, the knob has a shape corresponding to the cutout in the movable hasp so that the knob is configured to pass through the movable hasp for operating the combination hasp to an unlocked mode, an inner body configured for attachment to the knob and the base to allow rotational movement of the knob and the inner body relative to the base, and a lever positioned within the inner body and the knob and comprising a lock tail.

According to this and other exemplary aspects of the present invention, the base may include a lock-tail cutout formed therein and configured for receipt of the lock tail of the lever to prevent rotational movement of the knob and the inner body relative to the base when the combination hasp is in a locked mode.

According to this and other exemplary aspects of the present invention, the combination hasp is configured for operation to the unlocked mode when the lock tail of the lever is disengaged from the lock-tail cutout of the base.

According to this and other exemplary aspects of the present invention, the combination hasp may include a dial positioned for rotational movement within the knob and the inner body, a clutch positioned within the knob and the inner body and configured for corresponding rotational movement with the dial, a latch positioned within the knob and the inner body, at least part of the latch is positioned between the lever and the clutch, and the dial is positioned within the latch.

According to this and other exemplary aspects of the present invention, the base may include a main hole positioned therein, the lock tail cutout is positioned adjacent to the main hole and the base may include a rotation guided rail extending at least partially around the main hole, and the inner body may include a cylindrical body configured to extend through the main hole of the base, and a movement controller extending from the cylindrical body and configured for engagement with the rotation guided rail of the base.

According to this and other exemplary aspects of the present invention, the base may include a locking ring receiving cutout formed therein, and the cylindrical body of the inner body may include a locking ring cutout formed therein and configured for receipt of a locking ring, the locking ring is further configured to be disposed within the locking ring receiving cutout of the base to secure the inner body to the base while allowing for rotational movement of the inner body relative to the base.

According to this and other exemplary aspects of the present invention, the rotation guided rail of the base is configured to allow movement of the movement controller between a first position in which the lock tail of the lever is engaged with the lock tail cutout of the base and a second position in which the knob is positioned so as to allow operating of the combination hasp to the unlocked mode.

According to this and other exemplary aspects of the present invention, the clutch may include a true gate and at least one false gate.

According to this and other exemplary aspects of the present invention, the latch may include a protrusion and when the protrusion is positioned within the true gate the lock tail of the lever may be disengaged from the lock-tail cutout of the base to operate the combination hasp to the unlocked mode, and when the protrusion is engaged with the false gate the lock tail of the lever cannot be disengaged from the lock-tail cutout of the base.

According to this and other exemplary aspects of the present invention, the dial may include teeth and the clutch may include an extended fin configured for engagement with the teeth of the dial so that rotational movement of the dial is transferred to the clutch.

According to this and other exemplary aspects of the present invention, the combination hasp may include a button having an exterior surface at least partially extending from the knob and a lever tail contact surface configured for operative engagement with a button contact surface of the lever.

According to this and other exemplary aspects of the present invention, the lever may include a latch contact positioned on the lever opposite the button contact surface and configured for operative engagement with a lever contact surface of the latch, and movement of the button is transferred to the lever and the latch.

According to this and other exemplary aspects of the present invention, the button is configured for rectilinear movement within the knob, and the rectilinear movement of the button is transferred to rectilinear movement of the latch and lever within the knob and the inner body.

According to this and other exemplary aspects of the present invention, in the first position the knob is not aligned with the opening cutout of the movable hasp and the movable hasp cannot be disengaged from the base so that the combination hasp is in the locked mode, and in the second position the knob is aligned with the opening cutout of the movable and the movable hasp can be disengaged from the base so that the combination hasp may be operated to the unlocked mode.

According to this and other exemplary aspects of the present invention, the lock-tail cutout is positioned adjacent to a main hole of the base, at least a portion of a perimeter of the main hole is configured to urge the lock tail of the lever in a direction so as to maintain operable contact between the lever and the latch in order to retain the protrusion within the true gate of the clutch to inhibit rotation of the dial.

According to this and other exemplary aspects of the present invention, the combination hasp may include a spindle positioned in the inner body, and the clutch may include a hole formed therethrough for receipt of the spindle to allow rotation of the clutch about the spindle.

According to this and other exemplary aspects of the present invention, the combination hasp may include a second dial and a second clutch operatively connected to the second dial and configured for rotational movement together with the second dial, the dial and the second dial each have a plurality of indicia disposed thereon, one indicia from the plurality of indicia on the dial and the second dial form the correct combination for the combination hasp, and when the correct combination is input on the dial and the second dial the combination hasp may be operated to the unlocked mode.

According to this and other exemplary aspects of the present invention, the knob may include a rivet configured to engage with a rivet hole in the inner body to secure the knob to the inner body.

According to this and other exemplary aspects of the present invention, the combination hasp may also include a spindle spring configured to urge the spindle in a direction towards the latch and the lever in order to urge the lock-tail of the lever into the lock-tail cutout of the base when the combination hasp is in the locked mode.

According to this and other exemplary aspects of the present invention, a combination hasp is provided that may include a fixed hasp configured for mounting onto a fixture object by one or more fasteners, a movable hasp partially mounted to the fixed hasp and having a cutout formed therein, a knob with a shape that allows the cutout in the movable hasp to pass through for operating the combination hasp to the unlocked mode, and wherein the knob is configured for rotation to prevent the movable hasp from lifting open and operating the combination hasp to the unlocked mode, and wherein movement of the movable hasp is controlled by the rotation of the knob, a base operatively connected to the knob and configured for mounting onto the fixture object by one or more fasteners, an inner body configured to operatively connect the knob, base, and a locking ring, which is inserted into a locking-ring cutout of the base to ensure that the inner body and the knob function as a single unit, a set of dials mounted within the inner body and each dial of the set of dial is configured to allow rotation of a corresponding clutch of a plurality of clutches, wherein each of the clutches contain an extended fin that engages with teeth of the corresponding dial for synchronized rotation in the locked mode, a latch mounted within the inner body, with its movement controlled by the plurality of clutches, a button mounted to allow the user to push it inward when the dials are set to the correct combination, and a lever configured for control by the movement of the latch.

According to this and other exemplary aspects of the present invention, the base comprises a lock-tail cutout designed to receive a lock tail from the lever, thereby controlling the rotational movement of the knob from the locked position to the open position.

According to this and other exemplary aspects of the present invention, the base includes a rotation guided-rail to receive a movement controller of the inner body, thereby regulating the extent of the knob's rotation.

According to this and other exemplary aspects of the present invention, the knob comprises a rivet to engage with rivet holes in the inner body, and wherein the inner body is configured to houses the button, the latch, the lever, a spindle, the dials, and the clutches.

According to this and other exemplary aspects of the present invention, the latch includes a V-shaped protrusion to align with the true gates of the clutches for lock opening and align with the locking surface or false gates in the locked mode, wherein the latch further comprises a lever-contact surface designed to engage with the latch-contact surface of the lever, a spindle-contact surface to engage with the latch-contact surface of the spindle, such that when the latch is pushed, it also pushes the spindle, compressing the spindle spring, wherein this compression exerts force, causing the spindle, the latch, the lever, and the button to move outward when the knob is turned to the locked mode, thereby aligning and engaging the lock tail with the lock-tail cutout of the base.

According to this and other exemplary aspects of the present invention, in the unlocked mode, the knob rotates such that its shape aligns with the opening cutout of the movable hasp, allowing the movable hasp to lift open, and wherein to operate the combination hasp to the locked mode the knob rotates in a manner that misaligns its shape with the opening cutout of the movable hasp, thereby preventing the user from lifting the movable hasp open.

According to this and other exemplary aspects of the present invention, in the unlocked mode, the lock-tail of the lever is pushed inward without any cutout to allow the lock-tail to extend outward, as a result the button, the latch, and the lever are pushed inward, and the V-shaped protrusion of the latch fully engages with the true gates of the set of clutches, wherein this engagement prevents the user from rotating the dials in the unlocked mode, thereby avoiding accidental changes to the combination.

According to this and other exemplary aspects of the present invention, in the locked mode, the lock tail of the lever aligns with the lock-tail cutout of the base, and the spring in the spindle exerts force to push the spindle back to the lock position, wherein this movement also pushes the latch, the lever, the spindle, and the button back to the locked position, wherein the V-shaped protrusion of the latch moves away from the true gates of the set of clutches, allowing the user to scramble the dials and move the clutch from the true gate to the locking surface or false gates for locking wherein this action prevents the V-shaped protrusion from having enough room to travel back to the lock open state, ensuring that the lock tail of the lever always engages with the lock-tail cutout of the base, thereby securely locking the mechanism. According to this and other exemplary aspects of the present invention, the interaction between the button, lever, latch, and spindle results in a uniform lateral movement from the lock state to the open state when the V-shaped protrusion of the latch aligns with the true gates of the set of clutches, wherein the engagement of the lock-tail of the lever with the lock-tail cutout of the base controls the rotational movement of the knob, wherein when the lock-tail of the lever is engaged with the lock-tail cutout of the base, the knob cannot rotate, and wherein when the lock-tail of the lever is disengaged from the lock-tail cutout of the base, the knob can rotate in the designated direction as guided by the rotational guided-rail and the movement-controller of the inner body.

According to this and other exemplary aspects of the present invention, the sandwiched interaction causes the button, the lever, the latch, and the spindle to move uniformly from the unlocked mode back to the locked mode.

The reference numbers and corresponding elements are summarized below:

10 Combination Hasp
20 Fixed hasps
21 Screw holes
22 Hinge arch
30 Movable Hasp
31 Hinge holes
32 Opening cutout
40 Base
41 Screws holes
42 Main-hole
43 Lock-tail Cutout
44 Rotation Guided-rail
45 Locking-ring-receiving-cutout
50 Knob.
51 Button-cutout.
52 Dials-cutout.
53 Reset-clutch-cutout.
54 Rivet.
60 Inner-body.
61 Dials-cutout.
62 Small Diameter Clutch-cutout.
63 Big Diameter Clutch-cutout.
64 Spindle receiving-wall.
65 Latch-plate-edge.
66 Lever slot.
67 Locking-ring-cutout.
68 Rivet holes
69 Movement-Controller
70 Button
71 Exterior surface
72 Lever-tail contact surface
80 Latch
81 V-shaped-protrusion
82 Lever-contact-surface
83 Spindle-contact-surface
90 Lever
91 Button Contact Surface
92 Latch-contact-surface
93 Lock-tail
100 Spindle
101 Latch Contact Surface
102 Big Diameter
103 Small Diameter
110 Dial
111 Teeth
120 Normal Clutch
121 Extended-fin
122 holes
123 True gates
124 Locking-surface
125 False Gates
130 Reset-clutch
131 Extended-fin
132 Hole
133 True gates
134 Locking-surface
135 False gates
136 Reset Tail
140 Locking-Ring
150 Dial Ratchet Plate
160 Spindle Spring

### BRIEF DESCRIPTION OF THE DRAWINGS

For a fuller understanding of the nature and object of the present invention, reference should be had to the following detailed description taken in connection with the accompanying drawings, in which:

FIG. 1A is a top view of an exemplary combination hasp according to an aspect of the present invention in which the combination hasp is in a locked mode;

FIG. 1B is a side view of the exemplary combination hasp according to an aspect of the present invention in which the combination hasp is in the locked mode;

FIG. 1C is a cross-sectional view taken along line C-C from FIG. 1A;

FIG. 1D is a cross-sectional view taken along line D-D from FIG. 1B;

FIG. 2 is a perspective view of the exemplary fixed hasp configured for use with the exemplary combination hasp according to an aspect of the present invention;

FIG. 3 is a perspective view of the exemplary movable hasp configured for use with the exemplary combination hasp according to an aspect of the present invention;

FIG. 4A is a perspective top view of the exemplary base configured for use with the exemplary combination hasp according to an aspect of the present invention;

FIG. 4B is a perspective bottom view of the exemplary base configured for use with the exemplary combination hasp according to an aspect of the present invention;

FIG. 5 is a perspective bottom view of the exemplary knob configured for use with the exemplary combination hasp according to an aspect of the present invention;

FIG. 6A is a perspective top view of the exemplary inner-body configured for use with the exemplary combination hasp according to an aspect of the present invention;

FIG. 6B is a perspective bottom view of the exemplary inner-body configured for use with the exemplary combination hasp according to an aspect of the present invention;

FIG. 7 is a perspective view of the exemplary button configured for use with the exemplary combination hasp according to an aspect of the present invention;

FIG. 8A is a perspective bottom view of the exemplary latch configured for use with the exemplary combination hasp according to an aspect of the present invention;

FIG. 8B is a perspective bottom view of the exemplary fixed hasp configured for use with the exemplary combination hasp according to an aspect of the present invention;

FIG. 9A is a perspective view of the exemplary lever configured for use with the exemplary combination hasp according to an aspect of the present invention;

FIG. 9B is a perspective view of the exemplary lever configured for use with the exemplary combination hasp according to an aspect of the present invention;

FIG. 10 is a perspective view of the exemplary spindle configured for use with the exemplary combination hasp according to an aspect of the present invention;

FIG. 11 is a perspective view of the exemplary dial configured for use with the exemplary combination hasp according to an aspect of the present invention;

FIG. 12A is a perspective top view of the exemplary normal clutch configured for use with the exemplary combination hasp according to an aspect of the present invention;

FIG. 12B is a perspective bottom view of the exemplary normal clutch configured for use with the exemplary combination hasp according to an aspect of the present invention;

FIG. 13A is a perspective top view of the exemplary reset-clutch configured for use with the exemplary combination hasp according to an aspect of the present invention;

FIG. 13B is a perspective bottom view of the exemplary reset-clutch configured for use with the exemplary combination hasp according to an aspect of the present invention;

FIG. 14 is a perspective view of the exemplary locking ring configured for use with the exemplary combination hasp according to an aspect of the present invention;

FIG. 15A is a top view of the exemplary combination hasp according to an aspect of the present invention in which the combination hasp is in an unlocked mode;

FIG. 15B is a side view of the exemplary combination hasp according to an aspect of the present invention in which the combination hasp is in the unlocked mode;

FIG. 15C is a cross-sectional view taken along line C-C from FIG. 15A;

FIG. 15D is a cross-sectional view taken along line D-D from FIG. 15B;

FIG. 15E is a top view of the exemplary combination hasp according to an aspect of the present invention in which the combination hasp is in an unlocked mode;

FIG. 15F is a cross-sectional view of the exemplary combination hasp according to an aspect of the present invention in which the combination hasp is in the unlocked mode;

FIG. 15G is a front view of the exemplary combination hasp according to an aspect of the present invention in which the combination hasp is in an unlocked mode;

FIG. 15H is a cross-sectional view taken along line D-D from FIG. 15F;

FIG. 16A is a top view of the exemplary combination hasp according to an aspect of the present invention in which the combination hasp is in a reset mode;

FIG. 16B is a side view of the exemplary combination hasp according to an aspect of the present invention in which the combination hasp is in the reset mode;

FIG. 16C is a cross-sectional view taken along line C-C from FIG. 16A; and

FIG. 16D is a cross-sectional view taken along line D-D from FIG. 16B.

### DETAILED DESCRIPTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

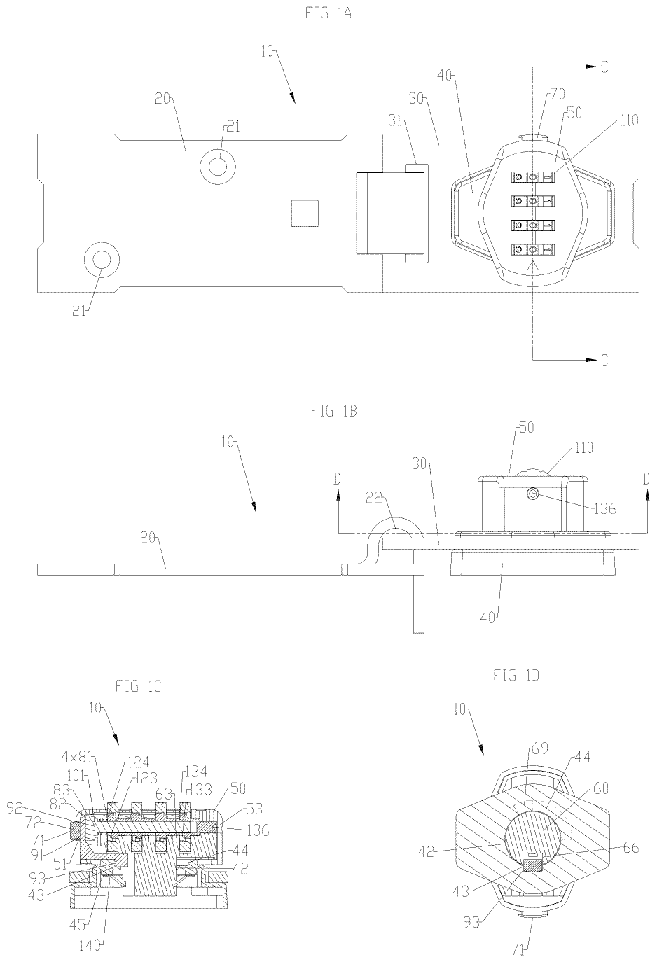

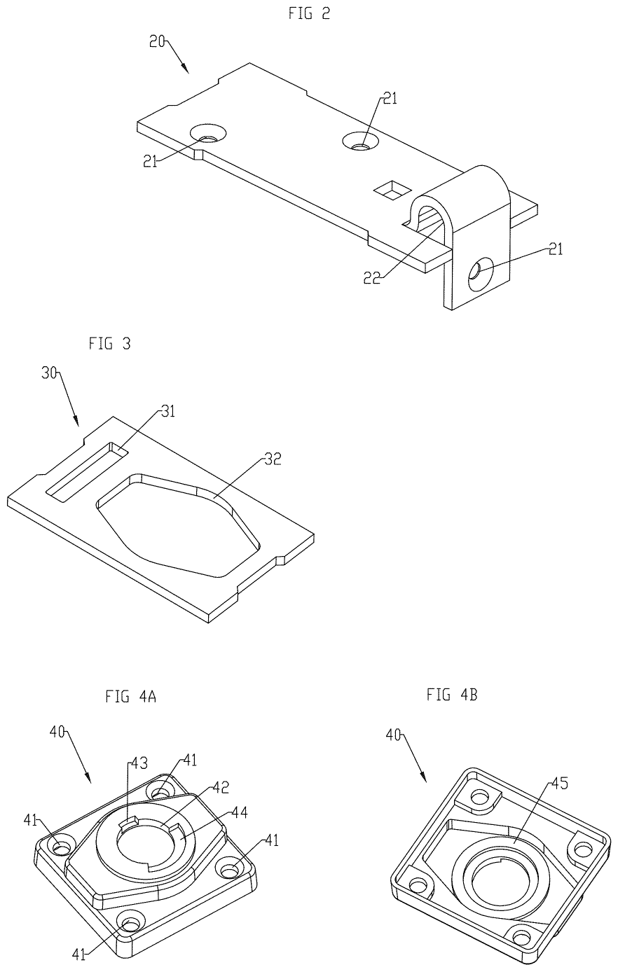

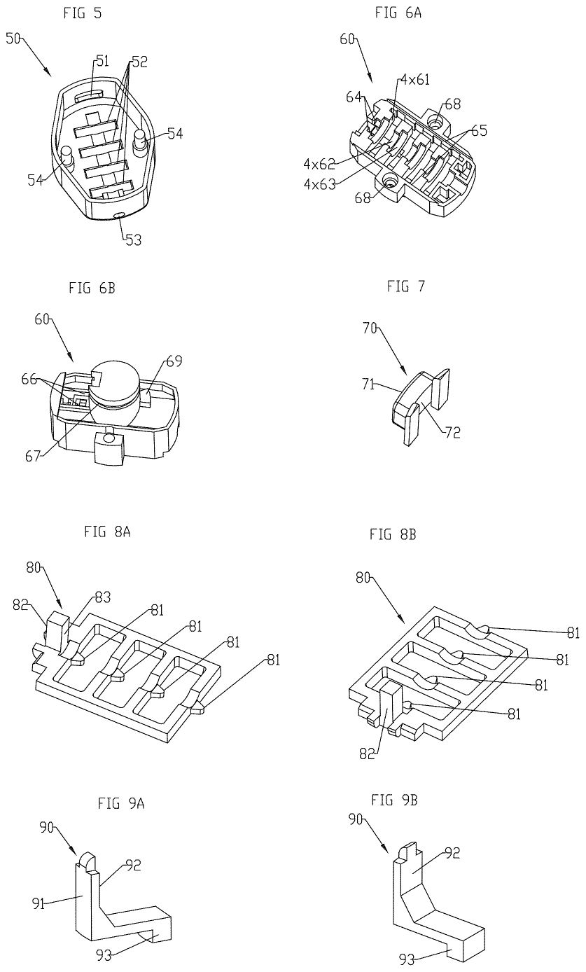

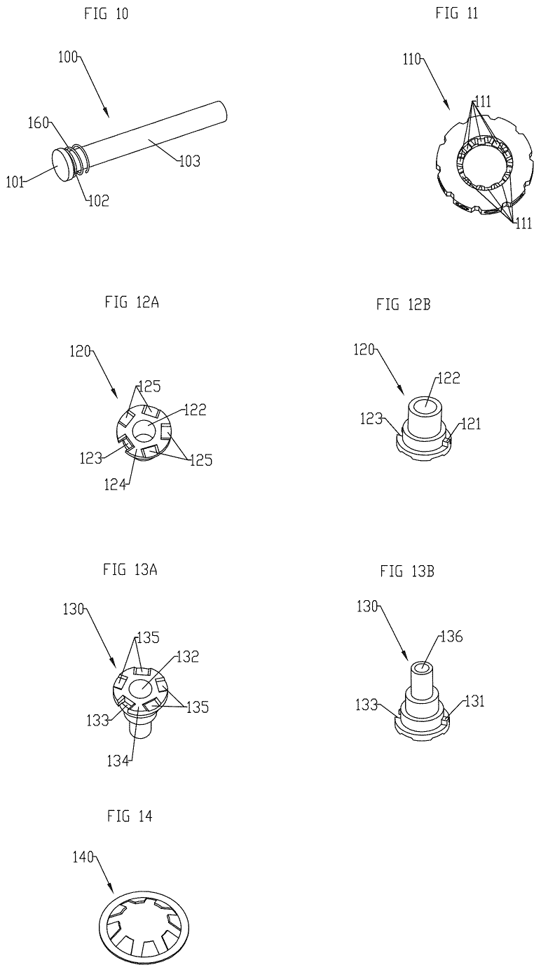

Referring now to FIGS. 1A-16D, therein illustrated is an exemplary embodiment of a combination hasp, generally indicated by reference numeral 10, according to an aspect of the present invention. The combination hasp 10 may include a fixed hasp 20 having one or more screw holes 21, which are configured to allow the combination hasp 10 to be secured to a fixture object, such as the fixed side of a gate or a wall adjacent to a door, by one or more fasteners (not shown). At least one of the screw holes 21 may be positioned so that during a locked mode of the combination hasp 10, the screw hole 21 is inaccessible so as to prevent unauthorized removal of the combination hasp 10 (see, e.g., FIG. 2). The fixed hasp 20 may also include a hinge arch 22 configured for engagement with a movable hasp 30 of the combination hasp 10. As shown for example in FIG. 2, the hinge arch 22 may include a screw hole 21 formed therein, which allows a fastener to secure the fixed hasp 20 to a side of the fixture object that is inaccessible when the combination hasp 10 is in the locked mode. The movable hasp 30 may include a hinge hole 31 configured to engage with the hinge arch 22, and an opening cutout 32. The opening cutout 32 may have at least substantially the same shape as a knob 50 of the combination hasp 10, and the knob 50 may be operatively connected to a base 40 of the combination hasp 10. The base 40 includes one or more screw holes 41 configured to allow the base 40 to be secured to an opening object, such as a door or gate, by one or more fasteners (not shown). The screw holes 41 may be covered by the movable hasp 30 when the combination hasp 10 is in the locked mode so as to prevent the fasteners from being removed. The base 40 may also include a main hole 42, a lock-tail cutout 43 formed in the base 40 adjacent to the main hole 42, and a rotation guided-rail 44 formed in the base 40 extending at least partially around the main hole 42. The base 40 may also include a locking-ring receiving-cutout 45 positioned on a side of the main hole 42 opposite the lock-tail cutout 43 and the rotation guided-rail 44. The knob 50 may be operatively coupled to the base 40 by an inner-body 60 that is configured for rotation relative to the base 40. The knob 50 may include a button-cutout 51 configured to allow an exterior surface 71 of a button 70 to protrude from the knob 50. The knob 50 and the inner-body 60 may include corresponding dial-cutouts 52/61, which in combination are configured to receive a dial 110, and allow rotation of the dial 110 within the dial-cutout 52/61. The knob 50 may also include a reset-clutch cutout 53, and one or more rivets 54 configured for engagement with the rivet holes 68 of the inner-body 60 in order to secure the knob 50 to the inner-body 60. The inner-body 60 may include one or more small diameter clutch-cutout 62 and one or more big diameter clutch-cutout 63, the combination of which are each configured to receive a normal clutch 120 or reset-clutch 130 within the inner-body 60. The inner-body 60 may also include a spindle-receiving wall 64, a latch plate-edge 65, a lever slot 66, and a locking-ring cutout 67 configured to receive a locking ring 140. The inner-body 60 may also include a movement-controller 69 configured for engagement with the rotation guided-rail 44 of the base 40. The button 70 may include a lever-tail contact surface 72 configured for engagement with a button contact surface 91 of a lever 90 in order to cause movement of a lock-tail 93 of the lever 90. The lock-tail 93 of the lever 90 may be engaged with the lock-tail cutout 43 of the base 40 when the combination hasp 10 in the locked mode in order to inhibit rotation of the knob 50 and inner-body 60 relative to the base 40. The lever 90 may also include a latch-contact surface 92 configured for engagement with a lever-contact surface 82 of a latch 80 of the combination hasp 10. The latch 80 may include one or more V-shaped protrusions 81 and have a spindle-contact surface 83 positioned opposite the lever-contact surface 82 and configured for engagement with a latch contact surface 101 of a spindle 100 of the combination hasp 10. The spindle 100 may include a big diameter 102 portion and a small diameter 103 portion and a spindle spring 160 may be disposed around the spindle 100. Each of the normal clutches 120 and the reset clutch 130 include a hole 122/132 configured to allow the clutches 120/130 to be installed around the spindle 100. Each of the clutches 120/130 may also include an extended-fin 121/131 configured for engagement with the teeth 111 of the corresponding dial 110. Each of the dials 110 has one or more indicia, which may be in the form of numbers, symbols, letters, colors or the like, corresponding to each tooth of the teeth 111. For example, in the exemplary embodiment illustrated ten indicia in the form of the numbers 0-9 are illustrated, and each of the dials 110 has ten teeth 111. A dial ratchet plate 150 may be positioned in the inner-body 60 in order to give an indication when a distinct indicia of the combination mechanism has been selected as the ratchet plate 150 will engage with indentations on the dials 110 positioned between each indicia. Each of the clutches 120/130 may also include a true gate 123/133 and one or more false gates 125/135. The true gate 123/133 and each of the false gates 125/135 are separated by locking surfaces 124/134. The reset clutch 130 may also include a reset tail 136.

Referring now to FIGS. 1A-14, the locked mode of the combination hasp 10 will now be discussed. The fixed hasp 20 of the combination hasp 10 may be secured to a fixture object, such as the fixed side of a gate (not shown). The moveable hasp 30 is configured to be affixed to the fixed hasp 20 as a result of engagement with the hinge hole 31 of the movable hasp 30 and the hinge arch 22 of the fixed hasp 20. This allows the movable hasp 30 to pivot within the hinge arch 22 area without falling out of the fixed hasp 20. When the combination mechanism of the combination hasp 10 has been set to the correct combination (lock open code) by selecting the appropriate indicia on the dials 110 so that the indicia on the dials 110 display the correct combination, the user can rotate the knob 50 so that the shape of the knob 50 aligns and matches with the opening cutout 32 of the movable hasp 30. This alignment ensures that there is nothing to block the movable hasp 30, allowing the user to lift the movable hasp 30 and flip it from the locked position (retained by knob 50 and inner-base 60) to the open position (shape of knob 50/inner-base 60 aligned with opening cutout 32). When the movable hasp 30 is in the locked position the combination hasp 10 is in the locked mode, and when the movable hasp 30 may be operated to the open position the combination hasp 10 is in the unlocked mode. In the locked mode, the dials 110 are not aligned to display all of the indicia in the correct order of the correct combination, and the knob 50 is in the locked position. In the locked position, the knob 50 is perpendicular to the opening cutout 32 of the movable hasp 30, meaning the shape of the knob 50 does not align or match with the opening cutout 32. Consequently, the user cannot lift the movable hasp 30 to open the combination hasp 10. The base 40 contains the screw holes 41 to allow fasteners, e.g., screws, to affix the base 40 into the opening object, such as the door or gate. This will prevent the base 40 from having any movement. The main-hole 42 of the base 40 allows the locking-ring-cutout 67 of the inner-body 60 to be placed through the base 40, and the locking-ring 140 to inserted in the locking-ring-cutout 67 to affix the inner body 60 and base 40 together. The base 40 contains the lock-tail-cutout 43 which is configured to receive the lock-tail 93 of the lever 90 when the combination hasp 10 in the locked mode. If the lock-tail 93 is engaged into this lock-tail cutout 43, the combination hasp 10 is in the locked mode, because the knob 50 cannot be rotated to align the shape of the knob 50 with the opening cutout 32 of the movable hasp 30. The lock-tail 93 of the lever 90 is configured to disengage away from the lock-tail-cutout 43 of the base 40, such that the knob 50 can be rotated from the locked position to the open position to operate the combination hasp 10 from the locked mode to the unlocked mode. Disengagement of the lock-tail 93 from the lock-tail-cutout 43 removes any obstruction to the cutout 43, freeing the knob 50 to rotate from the locked position to the open position. The knob's 50 rotation is governed by the rotational guided-rail 44 of the movement-controller 69 within the inner body 60, with the guided-rail 44 facilitating the transition of the knob 50 between the locked position and the open position. The knob 50 contains the button-cutout 51 to allow the exterior surface 71 of the button 70 to extend outside of the knob 50, enabling the user to push the button 70 to operate the combination hasp 10 to the unlocked mode when the correct combination has been set on the dials 110. As a result of the rivets 54 received by the rivet holes 68 of the inner-body 60, rotational movement of the knob 50 will be transferred to the inner-body 60. The knob 50 also contains the dial-cutout 52, which allows the dials 110 to extend outside, permitting the user to rotate the dials 110 to the correct combination. Additionally, the knob 50 features the reset-clutch-cutout 53, which allows the user to use a sharp object, such as a pen, to push the reset tail 136 of the reset-clutch 130 inside to operate the combination hasp 10 to the reset mode in order to reset and/or reconfigure the correct combination. The inner body 60 contains the dials-cutout 61 to receive the dials 110, and the small diameter clutch-cutouts 62 to receive the normal clutch 120 and reset clutch 130. The inner-body 60 may also include the big diameter clutch-cutout 63 to accommodate the larger portion of the locking surface 124 or 134 of the clutch 120 or reset clutch 130. The inner body 60 has a latch-plate-edge 65, which is designed to position the latch 80 and guide movement of the latch 80 within the inner body 60. Furthermore, the inner body 60 contains the lever slot 66, which is configured to allow operation of the lever 90 between the locked position and the open position. The button 70 contains the lever-tail contact surface 72 that is designed to contact the button contact surface 91 of the lever 90. When the dials 110 are in the correct combination, the user can push the exterior surface 71 of the button 70, causing the lever-tail contact surface 72 of the button 70 to contact the button contact surface 91 of the lever 90. As the button 70 continues to be pushed inward, the latch-contact surface 92 will push the lever-contact surface 82 of the latch 80, causing the latch 80 to move toward the open position. As a result of the correct combination having been selected on all of the dials 110, all true gates 123/133 of the normal clutch 120 and reset clutch 130 align with the corresponding V-shaped protrusions 81 of the latch 80, allowing all of the V-shaped protrusion 81 to push inward against the true gates 123/133. As the button 70 pushes inward, so do the lever 90 and the latch 80. In the locked mode, if at least one of the true gates 123/133 is not aligned with one of the corresponding V-shaped protrusions 81 of the latch 80, the latch 80 will not move, preventing the button 70 from being pushed inward to operate the combination hasp 10 to the unlocked mode. In the locked position, the lock-tail 93 of the lever 90 engages with the lock-tail cutout 43 of the base 40, restricting the knob 50/inner-body 60 from any rotational movement. In the locked mode, if at least one V-shaped protrusion 81 contacts the locking surface 124/134 or the false gates 125/135 of the clutch 120/130, the latch 80 will not be able to push inward enough to disengage the lock-tail 93 of the lever 90 from the lock-tail cutout 43 of the base 40. When engaged, the combination hasp 10 is in the locked mode, and the knob 50 cannot rotate, preventing it from aligning with the opening cutout 32 of the movable hasp 30 to allow opening of the combination hasp 10. The spindle receiving-wall 64 of the inner body 60 is designed to receive the spindle 100, allowing the spindle 10 to move within this area. The latch 80 further includes the spindle-contact surface 83 that is intended to contact the latch contact surface 101 of the spindle 100. In unlocked mode, as the button 70 pushes inward, so do the lever 90 and the latch 80, as described above. The latch 80 contains the spindle-contact surface 83 to push against the latch contact surface 101 of the spindle 100. The spindle 100 also contains a spring 160 placed between the large-diameter 102 of the spindle and the top of one of the normal clutches 120. The stack of the normal clutches 120 and the reset clutch 130 will be pushed inward as the button 70 pushes inward for operating the knob 50 to the open position. When the user re-locks the combination hasp 10, the user can rotate the knob 50 such that its shape is misaligned with the opening cutout 32 of the movable hasp 30. Then, the lock-tail cutout 43 and the lock-tail 93 align, and the spring 160 pushes the spindle back to its original locking position, such that the spindle 100, the latch 80, the lever 90, and the button 70 return to the locking position and the lock-tail 93 engages back into the lock-tail cutout 43. The spindle contains a small diameter 103 portion which is designed to pass through the holes 122/132 of the normal clutch 120 and reset clutch 130.

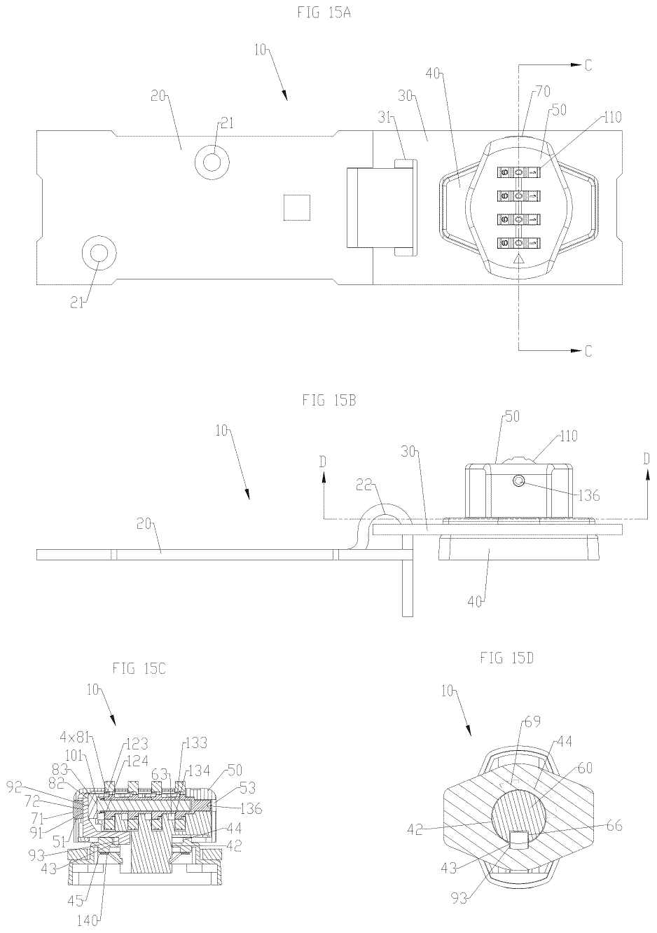

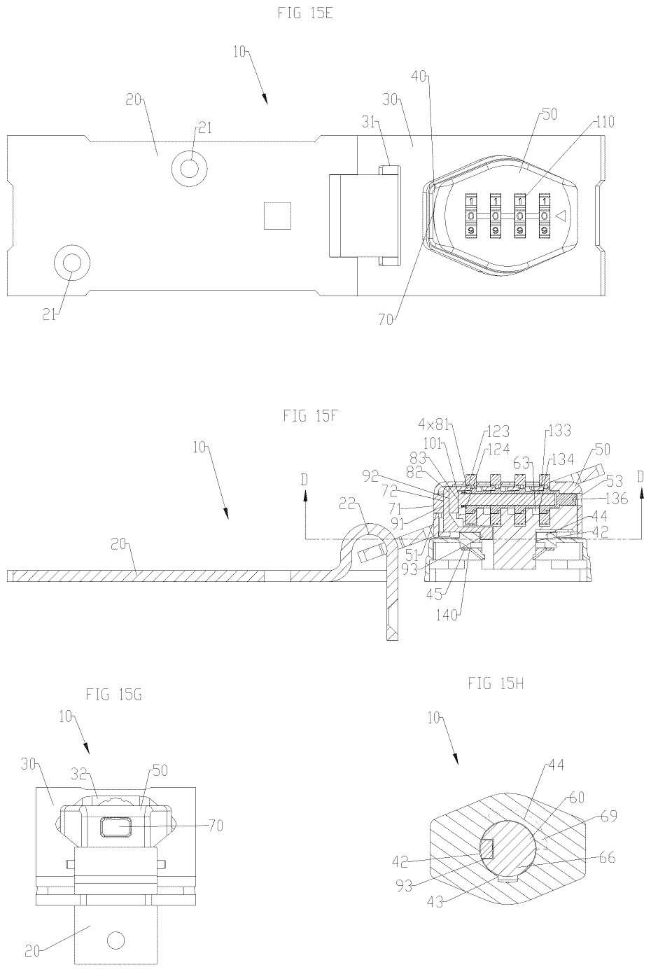

Referring now to FIGS. 15A-15H the unlocked mode of the combination hasp 10 will now be discussed. The dials 110 contain teeth 111 that, in both the locked mode and unlocked mode, engage the extended fins 121/131 of the clutches 120/130. Rotation of the dials 110 directly transfers to the clutches 120/130, aligning the V-shaped protrusion 81 of the latch 80 with the true gates 123/133 of the clutches 120/130 for operating the combination hasp 10 to the unlocked mode, and rotating the clutches 120/130 into locked mode to engage the V-shaped protrusion 81 with the locking surface 124/134 or the false gates 125/135 of the clutches 120/130. In the unlocked mode, the true gates 123/133 of the stack of clutches 120/130 align with the V-shaped protrusions 81. The user can then push the exterior surface 71 of the button 70, causing the lever-tail contact surface 72 of the button 70 to push the button contact surface 91 of the lever 90. This in turn causes the latch-contact surface 92 to push the lever-contact surface 82 of the lever 90, pushing the V-shaped protrusions 81 toward the true gates 123/133 of the clutches 120/130. As the lever 90 is pushed inward, the lock-tail 93 of the lever 90 moves out from the lock-tail cutout 43 of the base 40, allowing the knob 50 to rotate so that its shape aligns with the opening-cutout 32 of the movable hasp 30. This alignment enables the user to lift the movable hasp 30 away from the knob 50 and open the gate (not shown). During the unlocked mode, the user cannot rotate the dials 110 because the V-shaped protrusion 81 of the latch 80 is engaged with the true gates 123/133 of the clutches 120/130. Since the lock-tail 93 of the lever 90 is being pushed and there is no cutout to allow the lock-tail 93 to be pushed outward, the lever 90, the button 70, and the latch 80 are all jammed in the inward position during the entire unlocked mode. As the lever-tail contact surface 72 of the button 70 is pushed inward, the button contact surface 91 of the lever 90 is also pushed inward, making the latch-contact surface 92 contact the lever-contact surface 82. This jamming occurs because there is no cutout in the base 40 around the main hole 42 to receive the lock-tail 93 during the unlocked mode, creating a combination captive design that prevents the user from rotating the dials 110 in the unlocked mode when the knob shape 50 is aligned with the opening-cutout 32 of the movable hasp 30. This design helps prevent accidental changes to the correct combination. To relock, the user places the opening cutout 32 back into the knob 50, then rotates the knob 50 so that the profile of the knob 50 does not align with the opening-cutout 32 of the movable hasp 30. As the knob 50 rotates back to the locked position, the lock-tail 93 aligns with the lock-tail cutout 43 of the base, and the spring 160 pushes the latch 80, the lever 90, and the button 70 to the locked position. The V-shaped protrusion 81 of the latch 80 then disengages from the true gates 123/133 of the clutches 120/130. The exterior surface 71 of the button 70 pops outward of the button-cutout 51, allowing the user to scramble the dials 110, rotating the clutches 120/130 so that the true gates 123/133 do not align with the V-shaped protrusion 81 of the latch 80.

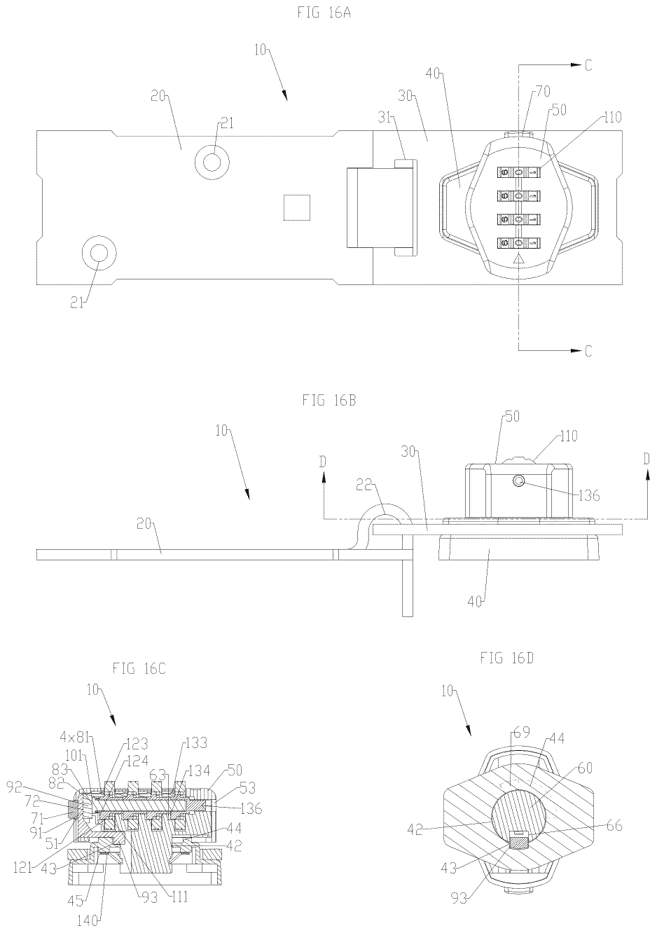

Referring now to FIGS. 16A-16D, the reset mode of the combination hasp 10 will now be discussed. When the user rotates all dials 110 to the correct combination aligning the true gates 123/133 of the clutch 120/130 with the V-shaped protrusions 81 of the latch 80 the user can push the reset tail 136 of the reset clutch 130 to place the combination hasp 10 into the reset mode, and allowing the stack of clutches 120/130 to move toward the large diameter 102 of the spindle 100, compressing the spring 160. As the clutches 120/130 move toward the large diameter 102, the extended fin 121/131 disengages from the teeth 111 of the dials 110, allowing the user to turn the dials 110 to select a desired new correct combination. After setting, the user may release the reset tail 136, and the spring 160 will push the stack of normal clutches 120 and the reset clutch 130 back to the original position, re-engaging the extended fin 121/131 with the teeth 111 of the dial 110. A ratchet plate 150 is placed to make rachet feeling to each rotation of the dials 110.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A combination hasp, comprising:
a fixed hasp configured for mounting onto a fixture object by one or more fasteners;
a movable hasp operatively connected to the fixed hasp and having a cutout formed therein;
a knob operatively connected with a base, wherein the knob has a shape corresponding to the cutout in the movable hasp so that the knob is configured to pass through the movable hasp for operating the combination hasp to an unlocked mode;
an inner body configured for attachment to the knob and the base to allow rotational movement of the knob and the inner body relative to the base;
a lever positioned within the inner body and the knob and comprising a lock tail;
wherein the base comprises a lock-tail cutout formed therein and configured for receipt of the lock tail of the lever to prevent rotational movement of the knob and the inner body relative to the base when the combination hasp is in a locked mode;
wherein the combination hasp is configured for operation to the unlocked mode when the lock tail of the lever is disengaged from the lock-tail cutout of the base.

2. The combination hasp according to claim 1, further comprising:
a dial positioned for rotational movement within the knob and the inner body;
a clutch positioned within the knob and the inner body and configured for corresponding rotational movement with the dial; and
a latch positioned within the knob and the inner body, wherein at least part of the latch is positioned between the lever and the clutch, and wherein the dial is positioned within the latch.

3. The combination hasp according to claim 1, wherein the base comprises a main hole positioned therein, wherein the lock tail cutout is positioned adjacent to the main hole and the base further comprises a rotation guided rail extending at least partially around the main hole; and
wherein the inner body comprises a cylindrical body configured to extend through the main hole of the base, and a movement controller extending from the cylindrical body and configured for engagement with the rotation guided rail of the base.

4. The combination hasp according to claim 3, wherein the base further comprises a locking ring receiving cutout formed therein, and wherein the cylindrical body of the inner body comprises a locking ring cutout formed therein and configured for receipt of a locking ring, wherein the locking ring is further configured to be disposed within the locking ring receiving cutout of the base to secure the inner body to the base while allowing for rotational movement of the inner body relative to the base.

5. The combination hasp according to claim 3, wherein the rotation guided rail of the base is configured to allow movement of the movement controller between a first position in which the lock tail of the lever is engaged with the lock tail cutout of the base and a second position in which the knob is positioned so as to allow operating of the combination hasp to the unlocked mode.

6. The combination hasp according to claim 2, wherein the clutch comprises a true gate and at least one false gate;
wherein the latch comprises a protrusion and when the protrusion is positioned within the true gate the lock tail of the lever may be disengaged from the lock-tail cutout of the base to operate the combination hasp to the unlocked mode; and
wherein when the protrusion is engaged with the false gate the lock tail of the lever cannot be disengaged from the lock-tail cutout of the base.

7. The combination hasp according to claim 2, wherein the dial comprises teeth and the clutch comprises an extended fin configured for engagement with the teeth of the dial so that rotational movement of the dial is transferred to the clutch.

8. The combination hasp according to claim 2, further comprising a button having an exterior surface at least partially extending from the knob and a lever tail contact surface configured for operative engagement with a button contact surface of the lever;
wherein the lever further comprises a latch contact positioned on the lever opposite the button contact surface and configured for operative engagement with a lever contact surface of the latch; and
wherein movement of the button is transferred to the lever and the latch.

9. The combination hasp according to claim 8, wherein the button is configured for rectilinear movement within the knob, and the rectilinear movement of the button is transferred to rectilinear movement of the latch and lever within the knob and the inner body.

10. The combination hasp according to claim 5, wherein in the first position the knob is not aligned with the opening cutout of the movable hasp and the movable hasp cannot be disengaged from the base so that the combination hasp is in the locked mode, and wherein in the second position the knob is aligned with the opening cutout of the movable and the movable hasp can be disengaged from the base so that the combination hasp may be operated to the unlocked mode.

11. The combination hasp according to claim 6, wherein the lock-tail cutout is positioned adjacent to a main hole of the base, wherein at least a portion of a perimeter of the main hole is configured to urge the lock tail of the lever in a direction so as to maintain operable contact between the lever and the latch in order to retain the protrusion within the true gate of the clutch to inhibit rotation of the dial.

12. The combination hasp according to claim 2, further comprising a spindle positioned in the inner body, and wherein the clutch comprises a hole formed therethrough for receipt of the spindle to allow rotation of the clutch about the spindle.

13. The combination hasp according to claim 2, further comprising a second dial and a second clutch operatively connected to the second dial and configured for rotational movement together with the second dial, wherein the dial and the second dial each have a plurality of indicia disposed thereon, wherein one indicia from the plurality of indicia on the dial and the second dial form the correct combination for the combination hasp, and wherein when the correct combination is input on the dial and the second dial the combination hasp may be operated to the unlocked mode.

14. The combination hasp according to claim 1, wherein the knob comprises a rivet configured to engage with a rivet hole in the inner body to secure the knob to the inner body.

15. The combination hasp according to claim 12, further comprising a spindle spring configured to urge the spindle in a direction towards the latch and the lever in order to urge the lock-tail of the lever into the lock-tail cutout of the base when the combination hasp is in the locked mode.
